(19) United States
(12) Patent Application Publication
(10) Pub. No.: US 2017/0001507 A1
(43) Pub. Date: Jan. 5, 2017

(54) Underbody for a Motor Vehicle

(71) Applicant: Faraday&Future Inc., Gardena, CA (US)

(72) Inventors: Umran Ashraf, San Diego, CA (US); Ye Jin, Carson, CA (US); Rene Johan Veltman, Torrance, CA (US); Gregory Scott Zinkel, Austin, TX (US); John Michael Colt, Redondo Beach, CA (US); Cory Denis Borghi, Torrance, CA (US)

(21) Appl. No.: 14/840,741

(22) Filed: Aug. 31, 2015

Related U.S. Application Data
(60) Provisional application No. 62/187,044, filed on Jun. 30, 2015.

(51) Int. Cl. B60K 1/04; B62D 25/20; B62D 21/03

(52) U.S. Cl. CPC B60K 1/04; B62D 21/03; B62D 25/2018; B62D 25/2027; B60K 2001/0438

(57) ABSTRACT

Underbodies for motor vehicles are provided herein. An example underbody is configured to form a hybrid uni-body with an upper body of an electric motor vehicle and the like. The underbody provides a configurable platform for use in multiple motor vehicle product lines, accommodating vehicles of various sizes having various upper bodies.

### CROSS REFERENCE TO RELATED APPLICATIONS

This application claims the benefit of U.S. Provisional Application No. 62/187,044, filed Jun. 30, 2015, which is hereby incorporated by reference here in its entirety, including all references and appendices cited therein.

### FIELD OF THE PRESENT DISCLOSURE

The present disclosure relates generally to an automobile frame and, more particularly, but not by way of limitation, to an underbody frame and design for electric and other motor vehicles.

### SUMMARY

According to some embodiments, the present disclosure is directed to a motor vehicle underbody comprising: (a) a battery sub-assembly, the battery sub-assembly comprising a cover and body, the body comprising a sidewall forming a battery cavity; (b) a scaleable outer peripheral frame forming an opening configured to receive the battery sub-assembly; (c) a front end configured to receive a front drivetrain; (d) a rear end configured to receive a rear drivetrain, the scaleable outer peripheral frame being disposed between the front end and the rear end; and (e) joints disposed along the scaleable outer peripheral frame for coupling the underbody to an upper body of the motor vehicle.

According to some embodiments, the present disclosure is directed to an underbody comprising: (a) a frame comprising: (i) a front bumper; (ii) a pair of tubular front rails extending from the front bumper; (iii) a pair of front end nodes that couple the pair of tubular front rails with a left center frame section and a right center frame section; (iv) a plurality of joints coupled to the left center frame section and right center frame section; (v) one or more front cross members extending between the pair of front end nodes; (vi) a rear bumper; (vii) a pair of tubular rear rails extending from the rear bumper; (viii) a pair of rear end nodes that couple the pair of tubular rear rails with the left center frame section and the right center frame section; (ix) one or more rear cross members extending between the pair of rear end nodes; and (x) the left center frame section, the right center frame section, the pair of front end nodes, and the pair of rear end nodes forming an outer peripheral frame.

According to some embodiments, the present disclosure is directed to a motor vehicle body, comprising: (a) an upper body; and (b) an underbody, wherein the underbody comprises: (i) a scalable (or adaptive) battery sub-assembly configured to hold a battery pack of different sizes, the battery sub-assembly comprising a cover and body, the body having a sidewall forming a battery cavity; (ii) a scaleable outer peripheral frame forming an opening configured to receive the battery sub-assembly; (iii) a front end for receiving a front drivetrain, the front end being configured to be selectively lengthened or shortened for accommodating upper bodies of differing lengths; (iv) a rear end for receiving a rear drivetrain, the rear end being configured to be selectively lengthened or shortened for accommodating upper bodies of differing lengths, the scaleable outer peripheral frame being disposed between the front end and the rear end; and (vi) joints disposed along the scaleable outer peripheral frame for coupling to the upper body of the motor vehicle.

### BRIEF DESCRIPTION OF THE DRAWINGS

Certain embodiments of the present disclosure are illustrated by the accompanying figures. It will be understood that the figures are not necessarily to scale and that details not necessary for an understanding of the technology, or that render other details difficult to perceive, may be omitted. It will be understood that the technology is not necessarily limited to the particular embodiments illustrated herein.

FIG. 1 is a perspective view of an underbody structure for the present disclosure according to an exemplary embodiment.

FIG. 2 is a top plan view of the underbody structure of FIG. 1.

FIG. 3 is an exploded perspective view of the underbody structure, in combination with a battery sub-assembly.

FIG. 4 is a cross sectional view of a front bumper of the underbody structure.

FIG. 5 is a cross sectional view of a front end rail of the underbody structure.

FIG. 6 is a bottom view of a front end of the underbody structure.

FIG. 7 is a top plan view of the of the underbody structure illustrating mounting rails of an exemplary upper body attached.

FIG. 8A is a side view of the underbody structure.

FIG. 8B is a side view of the underbody structure with exemplary upper body mounting rails attached.

FIG. 9A is a perspective view of an exemplary battery sub-assembly.

FIG. 9B is a perspective view of a body of the exemplary battery sub-assembly.

FIG. 9C is a perspective view of a cover of the exemplary battery sub-assembly.

FIG. 10 is an exploded perspective view of the exemplary battery sub-assembly.

FIG. 11 is a perspective view of a portion of an exemplary battery module.

FIG. 12 is a bottom view of a rear end of the exemplary underbody structure.

FIG. 13 is a top view of the exemplary underbody structure that illustrates various size configurable portions of the underbody structure that allow the underbody structure to be configured to accommodate various sizes of upper bodies of motor vehicles (with mounting rails of an exemplary upper body, that would attach to the underbody structure, also shown in this example).

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

The present disclosure provides exemplary underbody structures for motor vehicles. The underbody structure is also referred to as an underbody, a skateboard, or a chassis herein. In various embodiments, the underbody can form a hybrid uni-body with the upper body of the motor vehicle. Exemplary underbodies can provide an adaptable platform for accommodating different motor vehicle sizes and different vehicle upperbodies. The underbody of the present disclosure can enhance overall vehicle safety, for example, by having the battery pack centralized in the vehicle in various embodiments, resulting in greater crumple zone performance around the battery pack compared to existing vehicle designs. In addition, various embodiments of the underbody can, for example, provide for scalability to readily adapt to new vehicle platforms and provide for improved vehicle handling (yaw acceleration).

Provided are various embodiments of an underbody for a motor vehicle. The motor vehicle can be an electric vehicle, however, the present disclosure is not limited to use in electric vehicles. In various embodiments, the underbody can be configured to form a hybrid uni-body with the upper body and/or configured for use in multiple vehicle product lines, accommodating vehicles of various sizes having various upper bodies.

In some embodiments, a length of the adaptable platform can vary by increasing or reducing the length of certain structures between the front rails and the rear rails of the underbody.

In some embodiments, the width of the adaptable platform can vary by increasing or reducing the width of certain structures between the left side and right side that meets with an upper body of the vehicle.

The size of the battery can be selectively modifiable by virtue of a modular battery design.

The underbody can enhance overall vehicle safety, for example, due to having the battery being centralized in the vehicle, allowing for greater crumple zones around the battery compared to existing vehicle designs.

An upper portion (e.g., cover) of the battery enclosure can form all or part of a floor portion (assembly) of a passenger compartment of the motor vehicle. In some embodiments, the floor portion can be separate from the upper portion. An exemplary floor portion can extend longitudinally between a front section and a rear section of the battery cover. In some embodiments, an additional plate or panel can be included in the underbody that can separately, or together with the upper portion, form the floor portion of the passenger compartment. Additional cross members may be included to provide additional structural support.

Since the underbody according to various embodiments can function as the floor portion of the passenger compartment, the passenger compartment is not required to be completely separated from the underbody.

Other example embodiments of the disclosure and aspects will become apparent from the following description taken in conjunction with the following drawings.

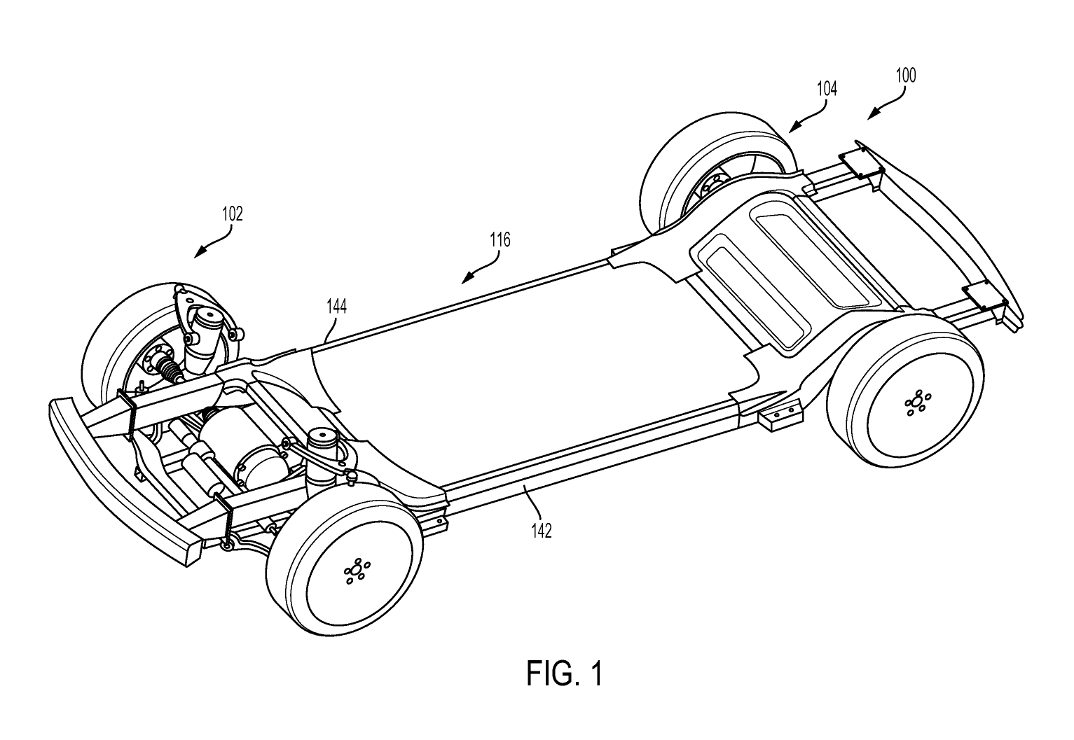

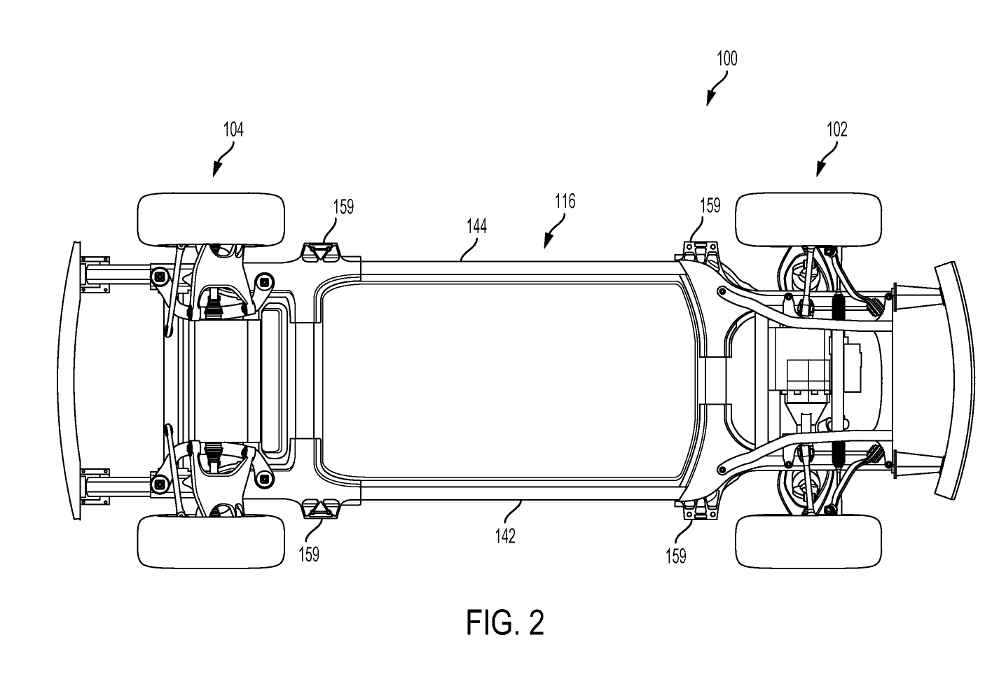

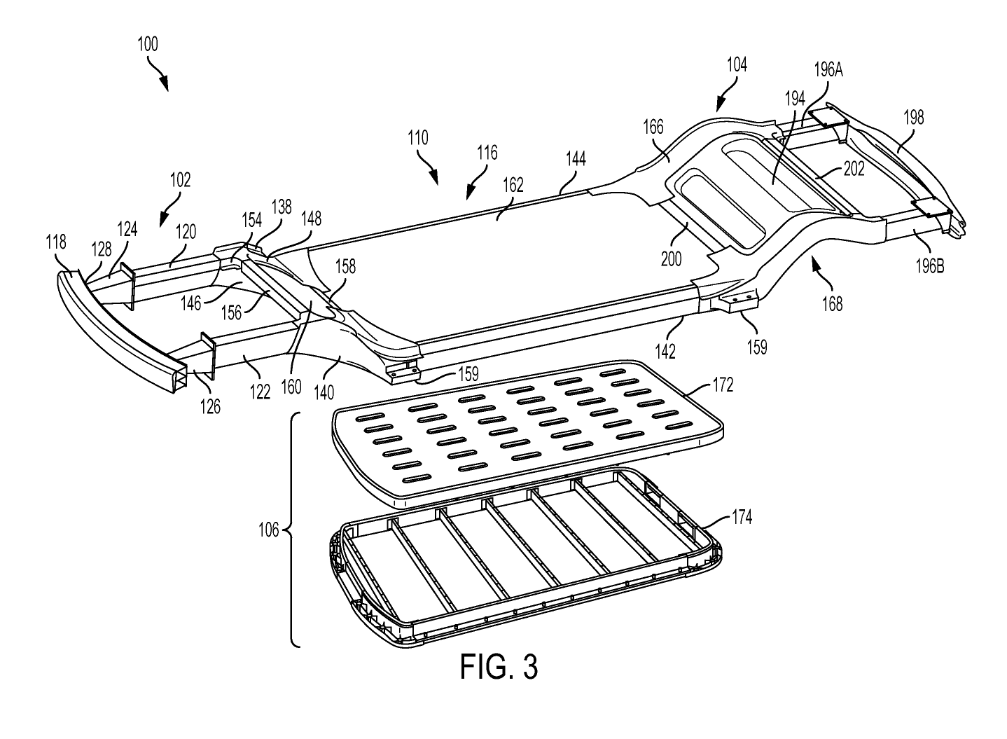

FIGS. 1 and 2, collectively illustrate an example underbody 100. FIG. 1 is a perspective view of the example underbody 100 that is constructed in accordance with the present disclosure. Generally, the underbody can include a front end 102, a rear end 104, a battery sub-assembly 106 (see FIG. 3), as well as other additional or fewer components as will be described in greater detail herein.

The front end 102 and rear end 104 can be spaced apart from one another by a middle section 116. The middle section 116 can include a left center frame section 142 and a right center frame section 144.

The underbody 100, in some embodiments, can be constructed from various materials or a single material. The material(s) utilized in the underbody 100 will be described with reference to each of the components or sub-assemblies of the underbody 100.

In general, the underbody 100 can be configured to cooperate with an upper body, as will be described in greater detail below. A common design for vehicles involves the use of body-on-frame technology, where a frame is coupled with the engine, drivetrain, portions of the vehicle's suspension system, and wheels of the vehicle. The remaining portions of the vehicle, referred to as the upper body, are joined to the frame. Safety, comfort, and aesthetic components of the vehicle are found in the upper body, such as seats. Having the seats mounted to the frame can increase the safety of the vehicle by providing the seats with a more substantial and connected relationship with the underbody of the vehicle. Indirect mechanical connections between the seat, the body, and ultimately the frame serve to reduce these features.

Also, in a traditional body-on-frame vehicle, the frame comprises a skeleton of tubular frame members, where the drivetrain (e.g., drive shaft) traverses/extends the length of the frame, which necessitates having a frame that is typically divided into a right handed section and a left handed section. These sections are then joined through the use of cross members.

Advantageously, the present disclosure provides an underbody with a middle portion 116 that can be continuous from a right hand side of a frame to a left hand side of the frame, which can increase a resistance of the underbody to twisting during impact.

Thus, the underbody designs of the present disclosure can benefit from the strength and stability of the monocoque (i.e., vehicle structure in which the chassis is integral with the body) design, but provide greater flexibility by allowing various body components to be placed onto the underbody, such as the outer panels of the upper body.

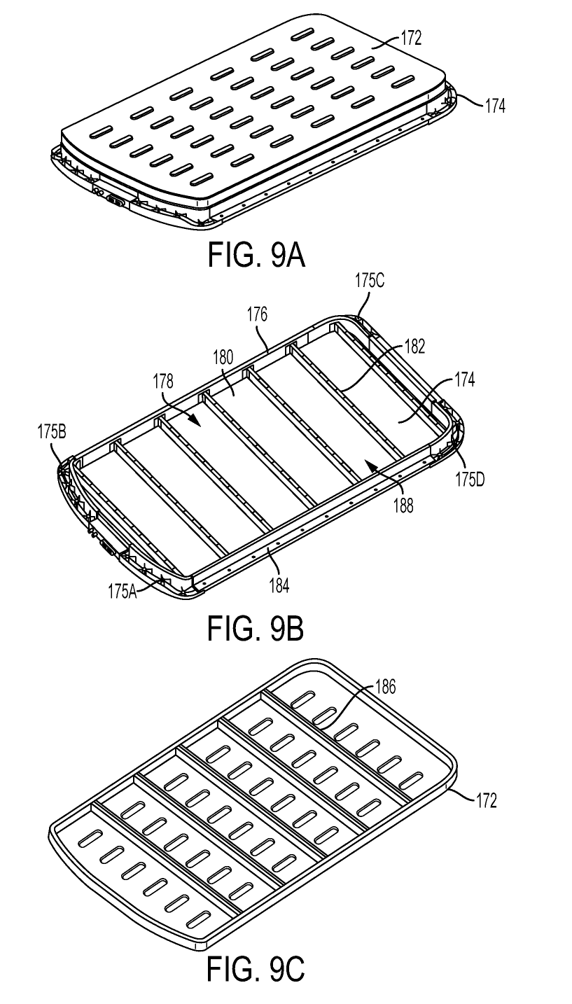

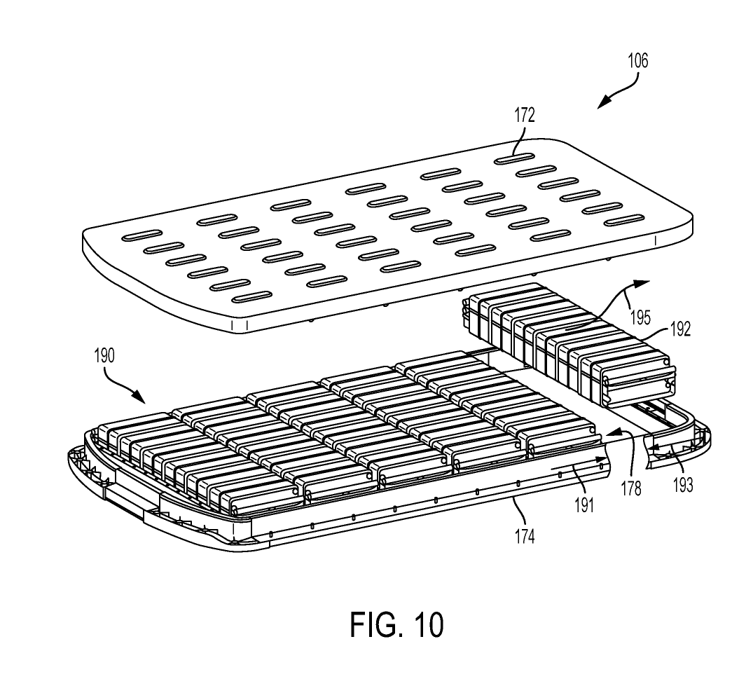

FIG. 3 is an exploded view of the underbody 100 that includes an outer peripheral frame 110 that illustrates a battery cover 172 and a body 174 (see FIGS. 9A-C) that holds the battery pack (see 190 in FIG. 10).

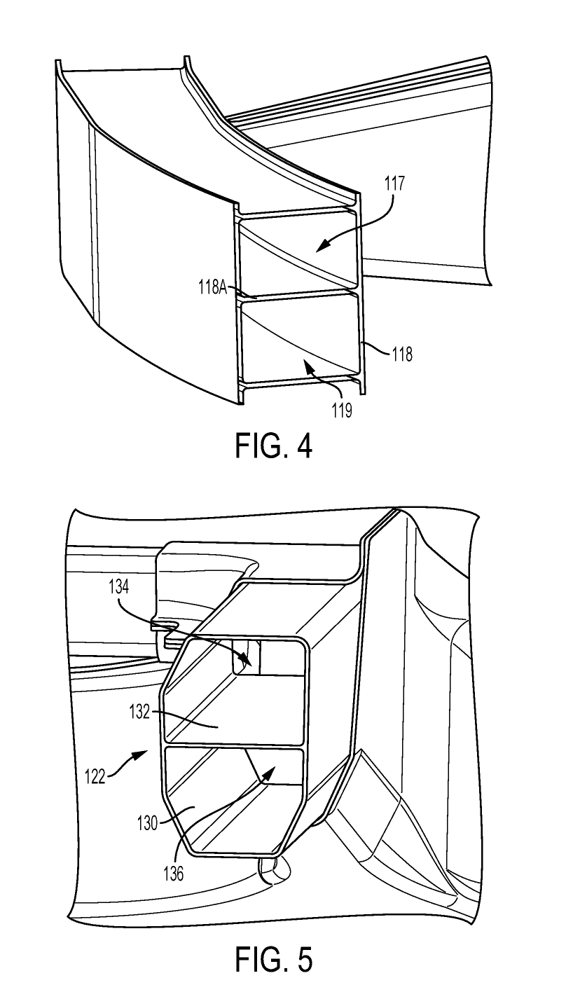

Turning now to FIGS. 3-6 collectively, described from front end 102 to rear end 104, the underbody 100 can comprise a front bumper 118. The front bumper 118 can be constructed from a cold rolled metal such as aluminum. As illustrated in FIG. 5, the front bumper 118 can comprise a divider web 118A that separates the front bumper into two sections, an upper section 117 and a lower section 119. The front bumper 118 can have a substantially tubular cross sectional area. In one embodiment, the front bumper 118 can have a substantially arcuate shape.

The front bumper 118 can be coupled with a pair of rails, such as first rail 120 and second rail 122. Connecting the front bumper 118 with the pair of rails can be the first crush can 124 and the second crush can 126.

Each of the rail crush cans 124 and 126 can be constructed similarly to one another and can be constructed from a sheet metal such as aluminum. In some embodiments, the crush cans 124, 126 can be made by casting or hydroforming. In one embodiment the first rail crush can 124 can have a substantially conical shape with flat outer face panel sections. Terminating one end of the first rail crush can 124 can be a mounting plate 128 that has an arcuate shape that conforms to an arcuate curvature of the front bumper 118. Again, the second rail crush can 126 can be constructed to form a complimentary mount for the second rail 122. It should be understood that other suitable mechanisms for coupling the front bumper 118 with the rails 120, 122 can also be adopted in other embodiments.

The first rail 120 and second rail 122 can be constructed similarly (e.g., as mirror images of each other) to one another and thus the second rail 122 will be described in greater detail with reference to FIG. 5. The second rail 122 can be a substantially tubular length of an extruded metal such as aluminum. The second rail can have various angled surfaces, such as angled surface 130, which can be altered according to design requirements such as desired crumple strength and motor sizing, for example. The second rail 122 can have a divider web 132 that provides structural support and divides the second rail 122 into an upper section 134 and lower section 136.

The underbody 100 can comprise frame transition sections, such as first transition section 138 and second transition section 140. The first and second transition sections 138 and 140 can be complementary (e.g., right handed, left handed) components. The first and second transition sections 138 and 140 can provide a narrowing connection between the left center frame section 142 and the right center frame section 144 (also illustrated in FIGS. 1 and 2).

For brevity and clarity, only the first transition section 138 will be described in detail. The first transition section 138 can comprise a lower segment 146 and an upper segment 148. The lower segment 146 can be manufactured from a high pressure die cast metal, such as aluminum. The lower segment 146 can be a high strength component that provides a compression point upon which the first and second rails 120 and 122 can crumple against.

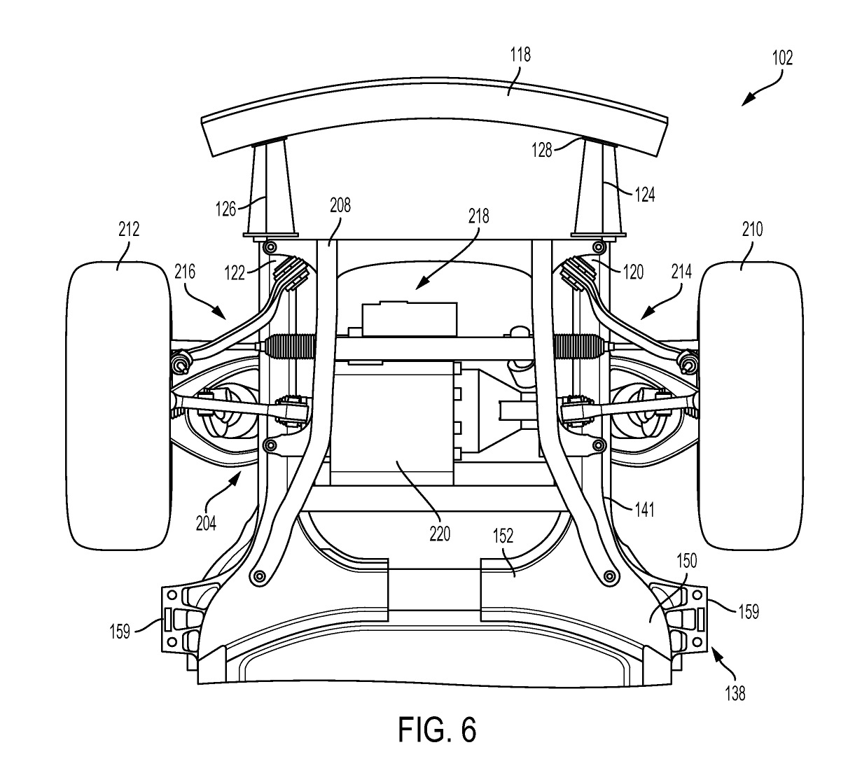

As illustrated in FIG. 6, the first transition section 138 can have a substantially T-shaped configuration with a rail coupling portion 141 and a frame section coupling portion 150. A transition tie section 152 can provide a mounting position for a front cross member, which is described below. Again, the second transition section 140 can have a similar, but complementary shape to first transition section 138.

In FIG. 3, the upper segment 148 of the first transition section 138 can cooperate with the lower segment 146 and include an opening 154 that receives a first front cross member 156 that ties the first transition section 138 and the second transition section 140 together, providing structural rigidity and stability to the underbody 100. The transition sections of the underbody 100 may be referred to as frame nodes. These frame nodes can provide structural rigidity and anchoring for the rails of the underbody.

A second front cross member 158 can extend between the first transition section 138 and the second transition section 140 for additional structural support. The upper segment 148 can include one or more sections and be configured to receive a front panel 160 that extends between the first transition section 138 and the second transition section 140 and the first and second front cross members 156 and 158. The front panel 160 can be manufactured from structurally rigid foam such as aluminum foam sandwich material.

The left center frame section 142 and the right center frame section 144 can extend between the front end 102 and the rear end 104. Extending between the left center frame section 142 and the right center frame section 144 can be a middle panel 162. The middle panel 162 may be manufactured from a structurally rigid foam such as aluminum foam sandwich material. The vehicle's passenger compartment is not required to be completely separated from the underbody according to various embodiments. For instance, the cover 172 of the battery sub-assembly 106 may be the middle panel 162, such that the cover 172 can form a floor section extending longitudinally along the middle section 116. In other embodiments, the cover 172 of the battery sub-assembly 106 can be coupled, from below, to a separate middle panel 162, the combination forming a floor section of the vehicle.

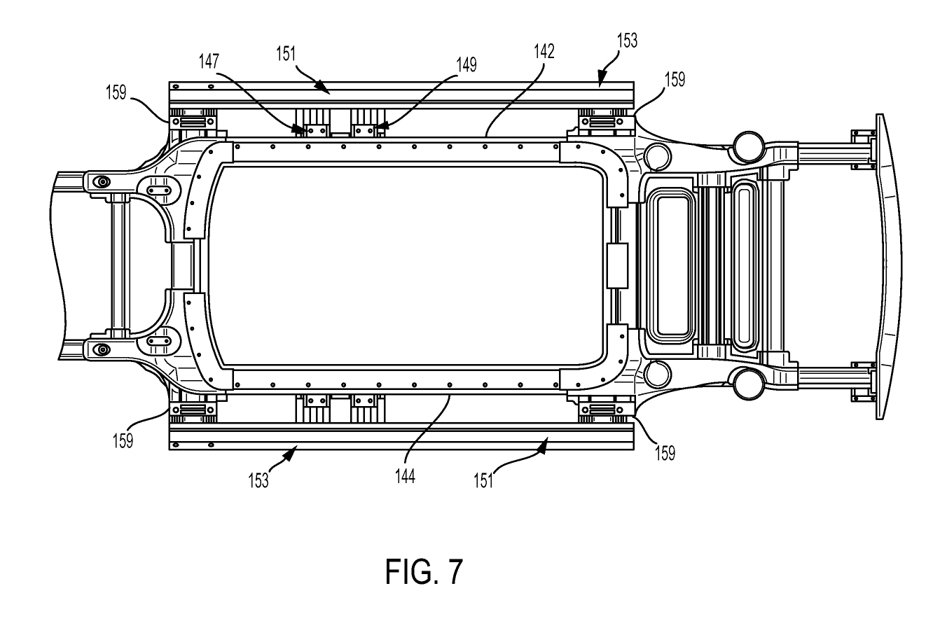

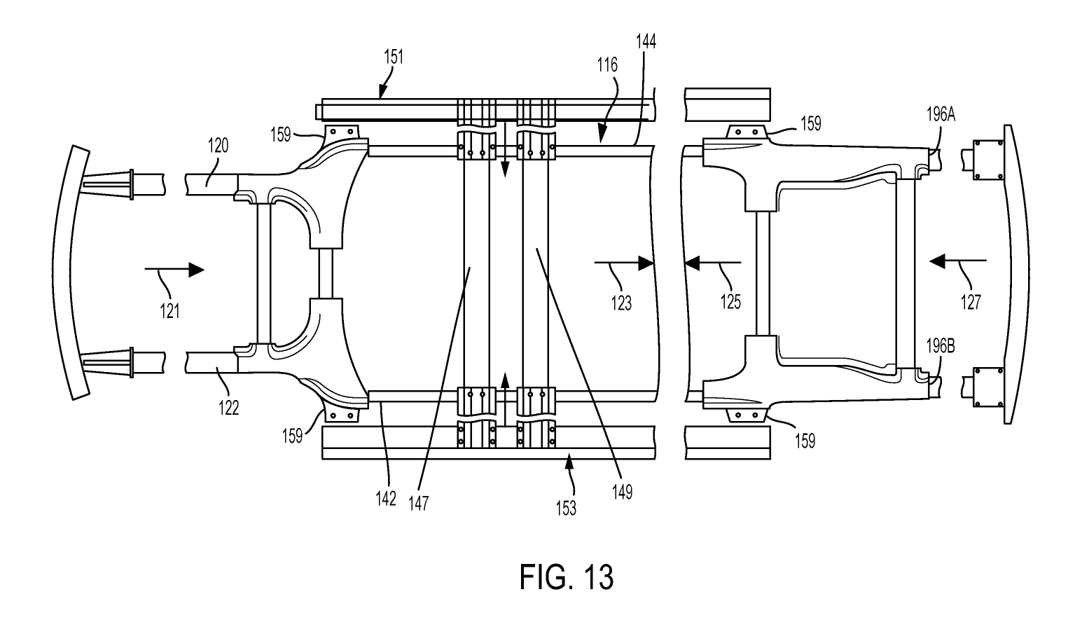

The underbody 100 can also comprise one or more support members, such as middle support members 147 and 149 (see FIG. 13). These middle support members 147 and 149 may extend between the left center frame section 142 and the right center frame section 144 and provide yet additional structural rigidity to the underbody 100. Each of the members can comprise mounting brackets that join the member to the upper body sills 153. As illustrated in FIG. 7, in some embodiments, each of the mounting brackets can comprise joints 159 that couple the middle support members 147 and 149 with upper body rails, which are described in greater detail below.

Various embodiments can provide structural stability to the underbody 100 reducing frame twisting and bending, which can occur during impact events. For example, if the underbody 100 is impacted at a the rear right corner, the impact force can apply a twisting or torque force onto the underbody as the wheels on the front end 102 tend to remain in contact with the road.

Referring again to FIG. 3, disposed along the left center frame section 142 and the right center frame section 144 can be a plurality of joints 159 that allow any upper body to be coupled with the underbody 100. Examples of the joints 159, for anchoring the upper body (not shown) to the underbody 100, are also shown in FIG. 7.

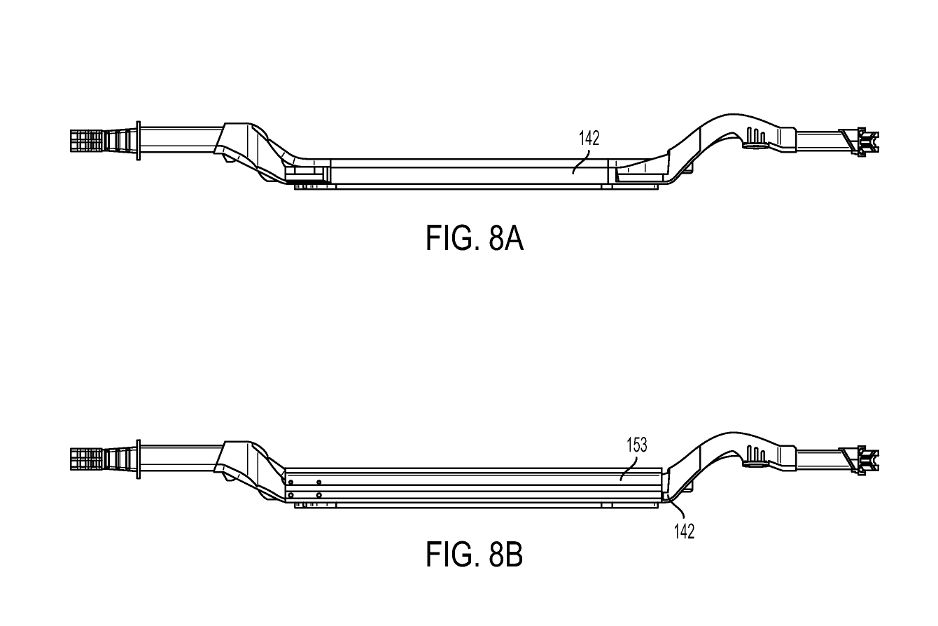

In FIGS. 8A and 8B, upper body sills, such as upper body sill 153, can be joined to the left center frame section 142 and the right center frame section 144 (sections 142 illustrated in FIG. 3). For example, upper body sill 153 can be joined to right center frame section 144. The upper body sill 153 can couple the upper body (not shown) to the underbody 100 in some embodiments.

Referring back to FIG. 3, the first transition section 138 and the second transition section 140 can cooperate with the left center frame section 142 and the right center frame section 144, as well as a third transition section (node) 166 and a fourth transition section (node) 168 of the rear end 104 to form a sidewall creating a cavity for receiving a portion of the battery sub-assembly 106 therein.

An example battery sub-assembly 106 is illustrated in FIGS. 9A-C. An assembled version of the battery sub-assembly 106 is provided in FIG. 9A. A cover 172 is illustrated in combination with a body 174.

FIG. 9B illustrates the exemplary battery sub-assembly 106 with the cover 172 removed. The body 174 can be defined by a sidewall 176 that forms a cavity 178 with a lower portion 180 of the body 174. The sidewall 176 can include corner braces 175A-D, which can be manufactured using a casting process, whereas the remainder of the sidewall 176 can be manufactured from extruded metal sections.

Extending between left and right sections of the sidewall 176 can be support ribs, such as support rib 182. The support ribs can lie transversely across the lower portion 180. In some embodiments, the body 174 can be provided with a flange or step 184 that allows the battery sub-assembly 106 to be coupled with the outer peripheral frame (see for example FIGS. 3 and 7). Thus, the battery sub-assembly 106 can be installed into the opening of the outer peripheral frame (see for example FIGS. 3 and 7).

The cover 172 of the battery sub-assembly 106 can also be provided with support ribs such as support rib 186. These support ribs 186 can form seals sealing the individual battery strings from each other when positioned against the support ribs 182 of the lower portion 180 of the body 174. Optionally, the support ribs can also provide structural support to the cover 172.

In some embodiments, the support ribs 182 of the body 174 and the support ribs 186 of the cover 172 can cooperate to form battery channels, such as battery channel 188. The battery channel 188 can be configured to receive a battery cell stack which may be a stack or string of individual battery modules, as will be described in greater detail below.

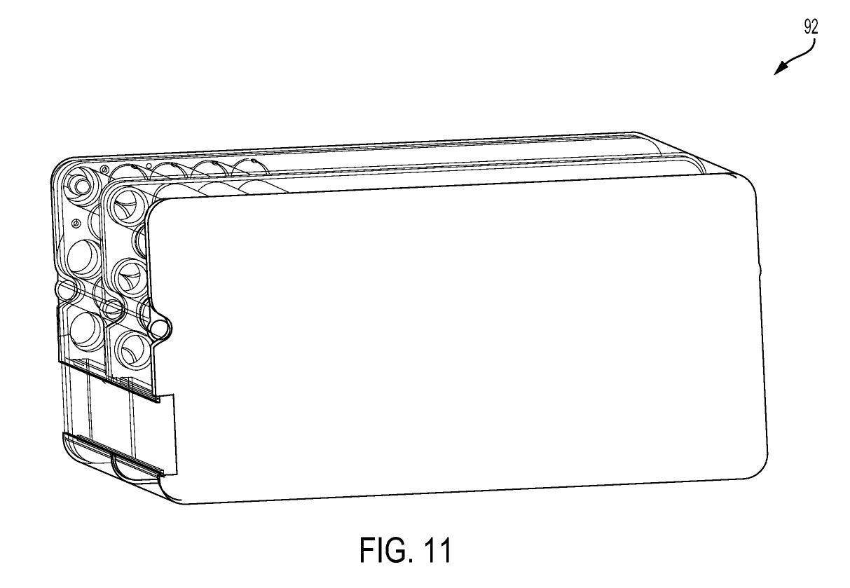

Turning now to FIG. 10, a battery pack 190 can include an array of battery strings or segments, such as battery cell stack 192 (also referred to as battery cell string or battery string). The battery cell stack can include a string of battery modules (see exemplary module in FIG. 11).

It will be understood that the size of the battery pack 190 can be selectively controlled by removing or adding battery segments. As the size of the battery 190 changes, the configuration of the underbody 100 can change. For example, the lengths of the left center frame section 142 and the right center frame section 144 can be lengthened or shortened according to design requirements. The arrow 195 illustrated in the example in FIG. 10 references the removal of a battery cell stack 192 to compress the size of the battery pack 190. Arrows 191 and 193 reference the removal of a battery channel 178 to compress the size of the body of the battery sub-assembly accordingly.

FIG. 11 illustrates a module 92 of the exemplary battery cell stack 192 (see FIG. 10).

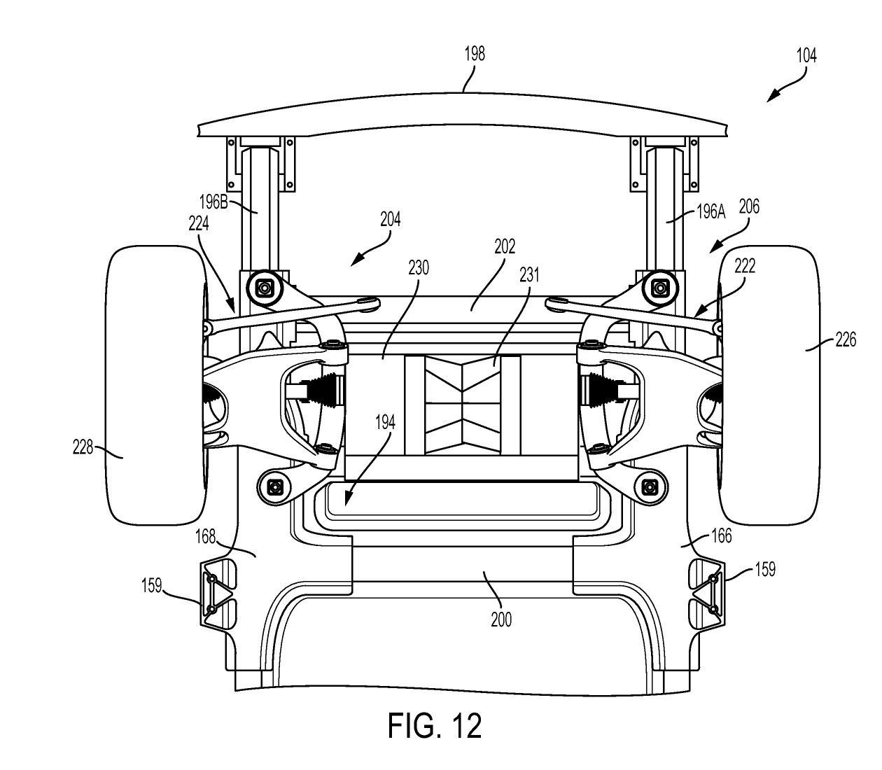

Referring now to FIGS. 3 and 12 collectively, the rear end 104 of the underbody 100 is illustrated as comprising a rear structural panel 194, the third transition section 166, the fourth transition section 168, as well as a pair of rear bumper rails 196A and 196B, and a rear bumper 198.

The rear structural panel 194 can be manufactured from an aluminum foam sandwich material or a rolled panel of metal. The rear structural panel 194 can be bounded by the third transition section 166 and the fourth transition section 168, as well as a first rear cross member 200 and a second rear cross member 202. FIG. 12 illustrates an upward view of the bottom of the rear end 104, which illustrates the rear structural panel 194, which can be configured to accommodate a rear drive assembly 204. Additional details regarding rear and front drive assemblies 204 and 206 will be described with reference to FIGS. 6 and 12 in greater detail below.

The rear bumper rails 196A and 196B can be constructed similarly to the first and second rails 120 and 122 of the front end 102 and cooperatively engage the rear bumper 198. The rear bumper 198 can comprise an arcuate configuration and can be tubular in its cross section, similarly to the front bumper 118 of the front end 102.

FIG. 13 is a top plan view illustrating various features of an exemplary adaptable platform that includes an exemplary underbody structure that can be selectively adjusted in size to accommodate upper bodies of differing sizes. In addition to showing an exemplary underbody, FIG. 13 also shows sills 151 and 153 which are part of an exemplary upper body. The adaptable platform can provide adaptability of the underbody for use in the assembly of multiple vehicle product lines. The adaptable platform (also referred as a “skateboard” platform) may accommodate vehicles of various sizes having various upper bodies. The length of the adaptable platform can vary by increasing or reducing the length of certain structures between the front rail and the rear rail, as illustrated by arrows 121, 123, 125, and 127 in the example in FIG. 13. For example, the first and second rails 120 and 122 can be selectively lengthened or shortened, as well as the rear bumper rails 196A and 196B. The size of the middle section 116 of the underbody 100 can be shortened or lengthened as needed. In some embodiments, the width of the adaptable platform can vary by increasing or reducing the width of certain structures. The size of the battery sub-assembly 106 may be changed, along with other underbody structures for accommodating different motor vehicle sizes and different vehicle upper bodies. The change in size to the battery sub-assembly 106 may require removing or adding one or more battery channels, such as battery channel 188 of FIGS. 9A-C, and corresponding change in the configuration of the battery pack. To be sure, these components can be sized independently from one another depending on design requirements.

Turning back to FIG. 6, the front end 102 can be configured to receive the front drive assembly, which in some embodiments can include a subframe 208 that can be mechanically coupled to the first and second rails 120 and 122, as well as the first and second transition sections 138 and 140, respectively. Wheels 210 and 212 can be supported on the front end 102 with a suspension assembly that comprises suspension sub-assembly 214 and 216, which couple wheels 210 and 212, respectively to the underbody 100. In the example in FIG. 6, the wheels 210 and 212 of the vehicle can be coupled to a front power plant 218 that can comprise an electric motor 220.

FIG. 12 illustrates the rear drive assembly 204 comprising a rear suspension assembly having rear suspension sub-assemblies 222 and 224, which are coupled to the wheels 226 and 228, respectively, with the underbody 100. The rear drive assembly 204 can comprise a rear power plant 230, which can also comprise one or more electric motors 231.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A motor vehicle underbody comprising:
a battery sub-assembly, the battery sub-assembly comprising a cover and body, the body comprising a sidewall forming a battery cavity;
a scaleable outer peripheral frame forming an opening configured to receive the battery sub-assembly;
a front end configured to receive a front drivetrain;
a rear end configured to receive a rear drivetrain, the scaleable outer peripheral frame being disposed between the front end and the rear end; and
joints disposed along the scaleable outer peripheral frame for coupling the underbody to an upper body of the motor vehicle.

2. The underbody according to claim 1, wherein the front end comprises a pair of front rails and a front bumper, further wherein the pair of front rails extend from a first transition section and a second transition section.

3. The underbody according to claim 2, wherein the front end further comprises a first front cross member and a second front cross member, further wherein a front panel extends between the front cross members and the transition sections.

4. The underbody according to claim 2, wherein the rear end comprises a pair of rear rails and a rear bumper, further wherein the pair of rear rails extend from a third transition section and a fourth transition section.

5. The underbody according to claim 4, wherein the pair of front rails, the pair of rear rails, or the battery sub-assembly is configured to be selectively lengthened or shortened.

6. The underbody according to claim 4, wherein the outer peripheral frame is defined by the first, second, third, and fourth transition sections, in combination with a left center frame section and a right center frame section.

7. The underbody according to claim 6, wherein the joints are coupled with the left center frame section and the right center frame section.

8. The underbody according to claim 7, wherein the left center frame section and the right center frame section each have a length that can be selectively varied.

9. The underbody according to claim 1, wherein the body of the battery sub-assembly comprises a flange or a step that extends from the sidewall, the flange comprising a mating surface for joining the enclosure to an underside of the outer peripheral frame.

10. The underbody according to claim 1, wherein a lower portion of the body of the battery sub-assembly comprises a plurality of support ribs defining battery channels.

11. The underbody according to claim 10, wherein the cover of the battery sub-assembly also comprises support ribs that extend along an underside of the cover in alignment with the plurality of support ribs of the lower portion.

12. An underbody, comprising:
a frame comprising:
a front bumper;
a pair of tubular front rails extending from the front bumper;
a pair of front end nodes that couple the pair of tubular front rails with a left center frame section and a right center frame section;
a plurality of joints coupled to the left center frame section and right center frame section;
one or more front cross members extending between the pair of front end nodes;
a rear bumper;
a pair of tubular rear rails extending from the rear bumper;
a pair of rear end nodes that couple the pair of tubular rear rails with the left center frame section and the right center frame section;
one or more rear cross members extending between the pair of rear end nodes; and
the left center frame section, the right center frame section, the pair of front end nodes, and the pair of rear end nodes forming an outer peripheral frame.

13. The underbody according to claim 12, wherein the outer peripheral frame is filled with a middle panel.

14. The underbody according to claim 12, wherein outer peripheral frame is configured to include a cavity for receiving a battery sub-assembly.

15. The underbody according to claim 14, wherein the battery sub-assembly comprises a cover and a body, the body comprising a flange or step configured to mate with an underside of the outer peripheral frame and a sidewall that is insertable within the cavity of the outer peripheral frame.

16. The underbody according to claim 12, wherein the pair of tubular front rails, the pair of tubular rear rails, or a panel filling the outer peripheral frame is configured to be selectively lengthened or shortened.

17. The underbody according to claim 15, wherein the size of the battery sub-assembly is configured to be selectively reduced.

18. The underbody according to claim 17, wherein the battery sub-assembly includes a plurality of battery modules and a number of the battery modules is related to the size of the battery sub-assembly.

19. A motor vehicle body comprising:
an upper body; and
an underbody, wherein the underbody comprises:
a scalable battery sub-assembly configured to hold a battery pack of different sizes, the battery sub-assembly comprising a cover and body, the body having a sidewall forming a battery cavity;
a scaleable outer peripheral frame forming an opening configured to receive the battery sub-assembly;
a front end for receiving a front drivetrain, the front end being configured to be selectively lengthened or shortened for accommodating upper bodies of differing lengths;
a rear end for receiving a rear drivetrain, the rear end being configured to be selectively lengthened or shortened for accommodating upper bodies of differing lengths, the scaleable outer peripheral frame being disposed between the front end and the rear end; and
joints disposed along the scaleable outer peripheral frame for coupling to the upper body of the motor vehicle.

20. The motor vehicle body according to claim 19, wherein the rear end comprises a pair of rear rails and a rear bumper, further wherein the pair of rear rails extend from a third transition section and a fourth transition section, further wherein the outer peripheral frame is defined by the first, second, third, and fourth transition sections, in combination with a left center frame section and a right center frame section, as well as a first rear cross member and a second rear cross member.
